(19) United States
(12) Patent Application Publication
(10) Pub. No.: US 2016/0086296 A1
(43) Pub. Date: Mar. 24, 2016

(54) Intellectual Property Finance Mechanism

(71) Applicant: Bluelron, LLC, Loveland, CO (US)

(72) Inventor: Russell S. Krajec, Loveland, CO (US)

(21) Appl. No.: 14/492,058

(22) Filed: Sep. 21, 2014

(51) Int. Cl. G06Q 50/18; G06Q 40/06

(52) U.S. Cl. CPC G06Q 50/184; G06Q 40/06

(57) ABSTRACT

A financing mechanism for intellectual property asset development finances the portfolio at a liquidation value over the life of the asset. A client company may assign their intellectual property assets to a holding company, and the client company may pay a payment to the holding company over the life of the asset. The client company may retain exclusive rights to the asset while payments are timely, but some or all of the rights may revert to the holding company when payments are not timely. The client company may have the option to purchase the assets or the holding company during the life of the assets.

### BACKGROUND

Startup companies and individual inventors often have a plethora of ideas but little cash to purchase the services of a patent attorney. They often realize the importance of patent protection, but do not have the wherewithal to finance adequate protection for their ideas.

### SUMMARY

A financing mechanism for intellectual property asset development finances the portfolio at a liquidation value over the life of the asset. A client company may assign their intellectual property assets to a holding company, and the client company may pay a payment to the holding company over the life of the asset. The client company may retain exclusive rights to the asset while payments are timely, but some or all of the rights may revert to the holding company when payments are not timely. The client company may have the option to purchase the assets or the holding company during the life of the assets.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram of an example embodiment showing relationships between entities for an investment in an intellectual property portfolio.

FIG. 2 is a flowchart illustration of an example embodiment showing interactions between a startup company and a holding company.

FIG. 3 is a diagram illustration of an example embodiment showing split risk investing using a holding company.

FIG. 4 is a diagram illustration of an example embodiment showing the use of a captive insurance company.

### DETAILED DESCRIPTION

An intellectual property portfolio may be financed for a client company by placing the portfolio in a second entity, such as a holding company, which may be financed separately from the client company. The holding company may be the assignee of some or all of the client company's intellectual property assets, and may be responsible for developing and managing a portfolio of one or more patents and other intellectual property assets. In some cases, the holding company may be a subsidiary of a management company that may have a line of business in intellectual property development.

The client company may be any company which may desire to finance an intellectual property portfolio without having to pay all of the costs and fees as those costs and fees are incurred. In many cases, the client company may be a startup company with little funding set aside for intellectual property development, in other cases, the client company may be a larger company that desires to spend capital on priorities other than intellectual property. In still other cases, the client company may be an individual inventor who may have limited funds for financing a new idea.

The intellectual property portfolio may contain patents, trademarks, trade secrets, schematics, product designs, or any other property that may be considered intellectual property. Throughout this specification, whenever a mention of a patent is used, it should be understood that other forms of intellectual property may be substituted for the term “patent”. With respect to the claims, the term “intellectual property” shall be used to designate any type of intellectual property, and the term “patent” or “patents” shall be used to designate “patent” or “patents” without the intent of substituting other types of intellectual property.

In one scenario, the holding company may value the intellectual property based on a liquidation price or other price that may be agreed upon between the holding company and the client company. In such a scenario, the client company may pay a recurring payment that may be calculated using a fixed or variable interest rate on the present or future value of the liquidation price. For example, a liquidation value of $100,000 for a patent may be financed at a 5% fixed interest rate over a 20 year life, leading to an annual payment of $7358.18. This is merely one example of a payment that may be calculated from a value of the intellectual property.

The holding company may be a corporation or other legal entity to which intellectual property may be assigned. The holding company may be owned by a management company or may be a standalone company with owners that are different from the client company. In some cases, the client company may take an ownership stake in the holding company. In such cases, the client company may or may not have a majority interest in the holding company, and whether or not the client company has a majority interest, the controlling interest may be held by a management company or individual.

The relationship between the client company and the holding company may be aligned in that the portfolio being developed may stem from the client company's intellectual property, and the holding company may have an aligned interest in developing a portfolio that can be monetized. The holding company's interest may be to develop a portfolio that may be licensed into the client company's market and to the client company's competitors. The holding company may also develop the portfolio with at least a partial intent to sell some or all of the portfolio into the marketplace, such as to patent aggregators, intellectual property assertion firms, contingency fee litigators, operating companies, or other entities.

The interests between the client company and the holding company are aligned in that both companies benefit from having a licensable and salable portfolio. A licensable portfolio benefits the client company as licensing may be one mechanism for the client company to leverage its technology into the marketplace. A licensing program may transfer the technology to a wide base of companies who can bring the technology to market. In general, a well-executed licensing program may leverage the capital of competitors to market, manufacture, distribute, support, and otherwise deliver the portfolio technology to customers, all the while receiving income from those activities of others. Likewise, the holding company benefits from a licensing program as such a program adds value to the portfolio and protects any liquidation value that the portfolio may have.

A salable portfolio drastically enhances the client company's acquisition prospects, as a buy-back provision may be exercised as part of an acquisition and may add to the total acquisition price. A salable portfolio benefits the holding company in the case of a default by the client company. At such an event, the holding company may liquidate the assets, and salable assets may allow the holding company to recoup its investment.

Investors to the client company may view the patent portfolio as a risk reducing factor. The monies invested into the client company may be viewed to be leveraged by the holding company's investment in the portfolio, and the portfolio may give the client company more business options without a large capital investment by the investors. In short, the client company's investors may have their investment capital leveraged by the holding company's investment, yielding a potentially higher return with a reduced risk. Such a situation may aid the client company in raising capital, either by getting better terms for the capital or by reducing the need for a larger investment.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

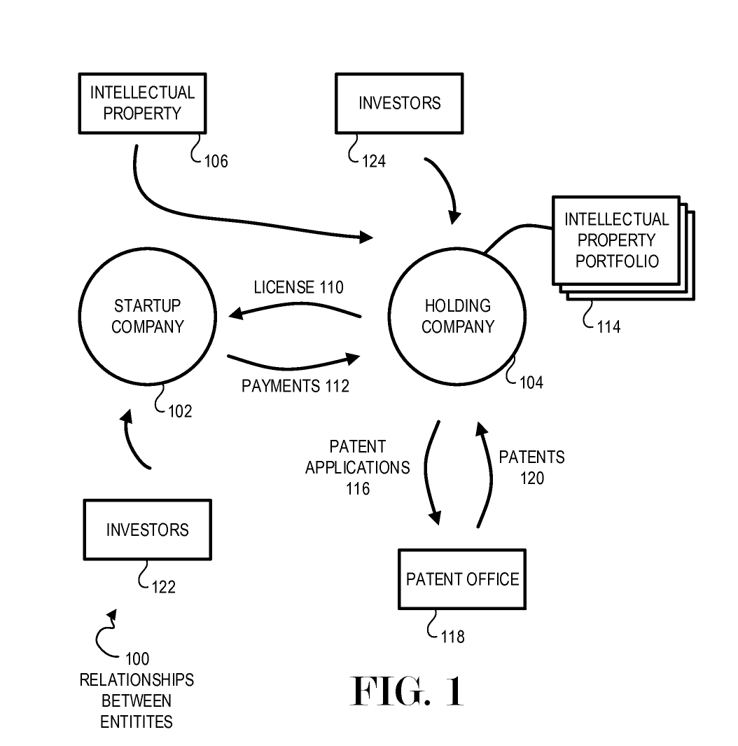

FIG. 1 is a diagram illustration of an embodiment 100, showing relationships and transactions that may occur between a startup company 102 and a holding company 104. Embodiment 100 is merely one simplified example of the interactions that may be used to finance intellectual property development for a startup company.

In the example of embodiment 100, the term “startup company” is used to represent one party and the term “holding company” is used to represent a second party in an intellectual property financing mechanism. The startup company 102 may represent an individual, corporation, or other entity that may generate and use intellectual property. The term “startup company” was selected because a use scenario may be for financing startup companies which may have limited funds, however, the same financing mechanism may be applied to companies with long histories or other institutions.

The holding company 104 may invest in the intellectual property and permit the startup company 102 to use the intellectual property in return for a financial payment. The holding company 104 may invest in the intellectual property by obtaining patents, for example.

The startup company 102 may be any entity that may desire access to intellectual property. Such entities may be individual inventors and entrepreneurs, startup companies with limited funds, operating companies, licensing entities, patent enforcement entities, non-government entities, non-profit entities, educational institutions, or any other type of organization.

The holding company 104 may be an entity which may invest in intellectual property that may be licensed to the startup company 102. The holding company 104 may be an entity such as a limited liability company, S-corporation, C-corporation, partnership, or other entity. In some embodiments, the holding company 104 may be specifically formed for an engagement with a startup company 102. In such an embodiment, the holding company 104 may be a limited liability company created to hold the intellectual property assets licensed to the startup company 102. Such an embodiment may be a subsidiary of a larger entity, where a new subsidiary entity may be created for each engagement with another startup company 102.

The startup company 102 may have intellectual property 106 that it may transfer to the holding company 104. In exchange, the holding company 104 may extend a license 110 to the intellectual property 106 and the startup company 102 may remit payments 112 to the holding company 104. The holding company 104 may develop an intellectual property portfolio 114 from the intellectual property 106 by obtaining patents and other services.

The holding company 104 may create patent applications 116 that may be submitted to various patent offices 118, which may issue patents 120. The patents 120 may become part of the intellectual property portfolio 114, which may be the subject of the license 110.

In some cases, the intellectual property 106 that makes up the intellectual property portfolio 114 may originate with the startup company 102. In other cases, the holding company 104 may contribute some or all of the intellectual property that makes up the intellectual property portfolio 114.

One type of engagement may have the startup company 102 contributing patentable ideas that the holding company 104 may cause to be patented. In such an engagement, the intellectual property 106 may be sold or transferred to the holding company 104 and “leased back” to the startup company 102. The startup company 102 may be the inventors listed on any patent applications and patents, yet the holding company 104 may pay for the cost of obtaining any patent assets.

Another type of engagement may have the holding company 104 taking a larger role in developing the intellectual property portfolio 114. In such an engagement, the holding company 104 may hire experts to develop patentable ideas in conjunction with or exclusive of inventors from the startup company 102. In each type of engagement, the startup company 102 may enjoy access to the intellectual property and potential purchase of the intellectual property developed under the agreement.

The engagement between the startup company 102 and the holding company 104 may benefit the startup company 102 by lowering the acquisition costs of an intellectual property portfolio 114. In so doing, the startup company 102 may enjoy a larger intellectual property portfolio 114 that it otherwise might afford.

In some cases, the startup company 102 may enter into such an arrangement to take the benefit of a holding company's expertise and focus on portfolio development. Many startup companies do not have expertise in portfolio development, and even when such expertise may exist, the startup company may not have the bandwidth or focus to devote to portfolio development. In such cases, outsourcing the portfolio development to a holding company 104 may be viewed as beneficial to the quality of the portfolio 114.

The holding company 104 may invest in the intellectual property portfolio 114 with the view that if the startup company 102 is unable to pay, the holding company 104 may have to liquidate the portfolio. With such a view, the holding company 104 may have a vested interest in selecting and curating the intellectual property portfolio 114 for resale or licensing.

A portfolio 114 that may be designed for resale or licensing may take into account the marketplace for the intellectual property. Such considerations may include tailoring the intellectual property for competitors to the startup company 102, or for broader licensing to other companies that may or may not compete with the startup company 102. Examples of such tailoring may include examining a competitor's products and crafting patent claims that may read on the competitor's products, analyzing a competitor's patent portfolio to identify missing elements that the intellectual property portfolio 114 may cover, identifying other marketplaces where the startup's technology may be applied and creating a portfolio for outbound licensing, as well as other strategies.

The startup company 102 may benefit from the holding company's focus on reselling or licensing the intellectual property portfolio. As the value of the portfolio 114 rises, the startup company 102 benefits as well. A portfolio 114 that has licensing potential may be realized when the startup company 102 enforces or licenses the portfolio 114, as well as the overall value of the startup company 102 in an acquisition scenario.

As part of the arrangement between the startup company 102 and holding company 104, the startup company 102 may have a buyout provision, where the startup company 102 may be able to purchase the portfolio 114. As the value of the portfolio 114 rises, the value of the startup company 102 rises to a third party that may acquire the startup company 102.

Embodiment 100 illustrates an example of where the holding company 104 may pay for and obtain patents to build an intellectual property portfolio 114. Other investments in intellectual property may also be made in different scenarios. For example, a holding company 104 may create a software or hardware platform that may be a reusable platform that may be able to be licensed into many use cases. In such an example, the holding company 104 may invest into software or hardware components that may be reusable, and the startup company 102 may focus its resources on delivering a specific use of the platform into a specific marketplace.

This is merely one example of a type of intellectual property portfolio that may be developed separately from the startup company 102. Other examples may be intellectual property that may be protected by copyright, utility patents, design patents, trade secrets, trademarks, and other mechanisms. The intellectual property may include media such as: audio, video, photographs, illustrations, paintings, artwork, and written media; designs which may be embodied in electrical schematics, mechanical drawings, or other media; recipes, processes, techniques, or other methodologies that may be embodied in training manuals, process descriptions, software, or other media.

A buyout or buyback provision of an agreement may permit the startup company 102 to purchase the intellectual property portfolio 114. When exercised, a buyback provision may permit the startup company 102 to take ownership of the intellectual property portfolio 114. In many cases, the relationship between the startup company 102 and the holding company 104 may be severed at the exercise of a buyback provision.

A buyback provision may be a fixed price for which the portfolio 114 may be purchased. For example, a portfolio 114 may be priced with a fixed price per patent, patent application, patent family, or other defined component. In some cases, the buyback price of the portfolio 114 may be constant over the life of an agreement. In other cases, the buyback price of the portfolio 114 may change over the life of an agreement.

A buyback provision may have a variable price for which the portfolio 114 may be purchased. The price may be determined by the status of the assets in the portfolio 114, such as whether a patent is pending or issued. In some cases, the price may be determined in part by the investment that the holding company 104 has made in the portfolio. In some cases, the financial success of the startup company 102 may be a factor in the buyback price, such as increasing or decreasing the buyback price based on whether the startup company 102 is being acquired as part of the buyback transaction, increasing or decreasing the price based on the startup company's profit or loss, or other factors.

In many cases, the buyback provision may be calculated from an algorithm or function that may be defined in an agreement between the startup company 102 and the holding company 104 at the start of an engagement.

In some embodiments, the buyback price of the intellectual property portfolio 114 may be determined at the time the startup company 102 wishes to exercise a buyback provision. In such an embodiment, a negotiation may be performed between the startup company 102 and the holding company 104 at the time the buyback may be requested. In one such embodiment, an agreement may include an independent evaluator or arbitrator that may determine a fair market value of the portfolio 114.

The holding company 104 may grant an exclusive license 110 to the startup company 102 at the beginning of an engagement. An exclusive license may indicate that the startup company 102 may be the only company that may receive the license. In some cases, the startup company 102 may be able to exercise many rights to the intellectual property portfolio 114, including the right to issue end user license agreements for its products, the right to enforce the portfolio against competitors, and other rights.

In some cases, the license 110 may permit the startup company 102 to exercise some rights without notifying the holding company 104, but not with other rights. For example, a license 110 may not permit the startup company 102 to encumber some or all of the intellectual property portfolio 114. In situations where an encumbrance may be made outside the permitted scope of the license 110, the startup company 102 may be able to exercise a buyout option and then encumber the portfolio 114.

Different sets of investors 122 and 124 may invest in the startup company 102 and holding company 104, respectively. The investors 122 may invest in the startup company 102, while the investors 124 may invest in the holding company 104 and the intellectual property portfolio 114. The investments made by each of the investors 122 and 124 may have different risk profiles and different types of return.

Investors 122 that invest in a startup company 102 may be making a high risk, high return investment. Such investments may be made considering the business plan, management competencies, personnel, competitors, and other considerations, and such investments may typically be made by so-called angel investors, venture capital funds, private equity funds, or other investors.

Investors 124 that invest in the holding company 104 and the intellectual property portfolio 114 may be making a relatively lower risk, lower return investment than the investors 122. An investment in the holding company 104 may be backed by the assets of the intellectual property portfolio 114, as a failure to obtain income from the startup company 102 may trigger the ability for the holding company 104 to liquidate the intellectual property portfolio 114. Such liquidation may include licensing or sale of the portfolio 114 to the startup company's competitors, sales of some or all of the portfolio 114 to non-practicing entities, licensing firms, operating companies, or other buyers. Because a liquidation option may be possible, investors 124 in the holding company 102 and the intellectual property portfolio 114 may have less risk of losing the initial investment.

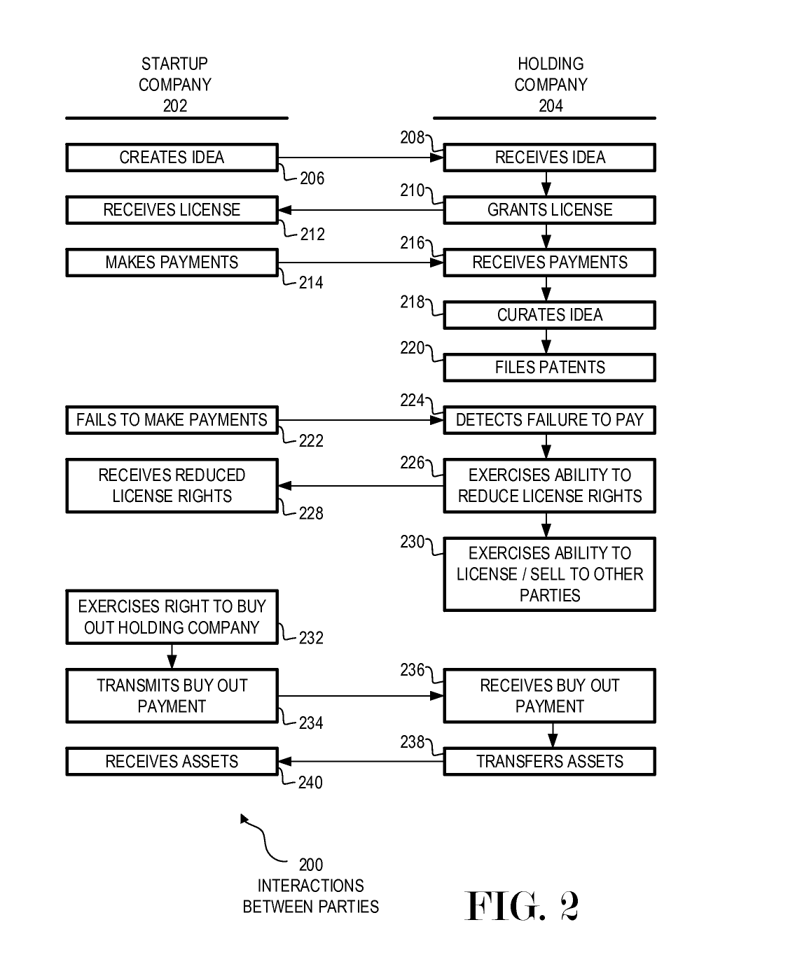

FIG. 2 is a flowchart illustration of an embodiment 200 showing interactions between a startup company 202 and a holding company 204. The operations of the startup company 202 are illustrated in the left hand column, while the operations of the holding company 204 are illustrated in the right hand column.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 200 illustrate some of the interactions that may be performed between a startup company 202 and a holding company 204 to develop patents that may protect a startup company 202. The ideas may originate with the startup company 202, and the startup company 202 may enjoy an exclusive license to the ideas. Rather than paying for patents directly, the startup company 202 may pay the holding company 204 to develop and manage the patents.

The operations illustrated in embodiment 200 may be embodied in a contract, operating agreement, or other legal document or set of legal documents that may define the roles, responsibilities, and obligations of the startup company 202 and holding company 204 with respect to each other. In some cases, the startup company 202 and holding company 204 may be distinct legal entities that are separately owned and operated. In other cases, the startup company 202 and holding company 204 may be partially or wholly owned by common owners. In still other cases, the startup company 202 may be a wholly owned or partially owned subsidiary of the holding company 204, or the holding company 204 may be a wholly owned or partially owned subsidiary of the startup company 202. In yet other cases, either the startup company 202 or holding company 204 may be a joint venture with a third party.

A startup company 202 may create ideas in block 206. The ideas may be transferred to the holding company 204, which may receive the ideas in block 206. The transfer may include a purchase by the holding company 204 from the startup company 202. The holding company 204 may purchase patentable ideas from the startup company 202 to capitalize the resulting patent application for tax purposes.

In some cases, the agreement between the startup company 202 and holding company 204 may be on a case-by-case basis or limited to a defined set of patentable ideas. In such a case, the startup company 202 may select specific ideas that it desires the holding company 204 to protect, and may then transfer the ideas to the holding company 204.

In some cases, the holding company 204 may receive a blanket assignment where all of the potentially patentable ideas of the startup company 202 are transferred to the holding company 204. In such cases, the holding company 204 may determine, at least in part, which ideas to protect with patents. In some such cases, either or both of the startup company 202 or holding company 204 may have decision power to pursue or not pursue patent protection for a given idea. An arrangement may allow either party to deny or to cause an idea to go forward with patent protection. In some such cases, either party may be able to select a number of ideas for protection.

An agreement between a startup company 202 and holding company 204 may be scoped for a minimum or maximum number of patent applications to file. For example, an agreement may define that a first number of patent applications will be filed in a first timeframe, such as a year or quarter, a second number of patent applications will be filed in a second timeframe, and so on. Such an agreement may be a multi-year arrangement.

An agreement between the parties may be an open-ended agreement where a startup company 202 may select ideas for patent protection that the holding company 204 may agree to prepare and file patent applications for as many or as few ideas as may be selected by the startup company 202. One embodiment of such an agreement may have a predetermined price schedule per patent application.

The holding company 204 may grant a license in block 210, and the startup company 202 may receive the license in block 212. The license of block 210 may permit the startup company 202 to use the technology that may have been received by the holding company 204 in block 208. In some cases, the license may include additional technology, such as technology that the holding company 204 may develop, purchase, or otherwise contribute.

The license of block 210 may be an exclusive license in some cases. An exclusive license may permit the startup company 202 to exclude others from using the licensed technologies. In some cases, the license may permit the startup company 202 to sublicense the technologies.

The license of block 210 may have limitations on what the startup company 202 may do with the technology. An example of such a limitation may permit the startup company 202 to sublicense the technology as part of an end user license agreement or other license that may accompany a product or service sold by the startup company 202, but such a limitation may not permit sublicensing in other situations. For example, the startup company 202 may be limited on whether it may sublicense the licensed technology to competitors or to a third party. Such a limitation may further include a predefined term of any such sublicense, where the holding company 204 may retain a right to optionally refuse such a sublicense or may include a percentage royalty that the holding company 204 may be paid as part of such a sublicense.

The startup company 202 may make payments in block 214 that may be received in block 216. The payments may be defined according to a schedule in a license agreement. The schedule may have fixed or variable payments. A fixed payment may be a recurring payment, such as a monthly, quarterly, or yearly payment, where the payment is predefined. Such a payment may be calculated based on the status of a patent application.

For example, the payment related to a specific patent application may change as the patent application progresses through a patent office. In one such example, a monthly payment at a first level may be established when the application is filed, then the payment may increase as an office action is received, and may increase further when the patent is issued.

In a different example, a payment may be calculated based on a corpus of patent applications. A holding company may agree to provide a range of number of patents that may protect a startup company. The holding company may seek to file a total number of patents, and the payment schedule may be based on the total number of patents to be filed. In some examples, the payment may be based on the number of patents filed to date, and such a payment may increase as the number of patents is filed.

The holding company 204 may curate ideas in block 218 and file patents in block 220. In some cases, the holding company 204 may use external resources to generate patentable ideas, and these patentable ideas may be assigned to the holding company 204 as part of the patent portfolio for which the startup company 202 has access. In many cases, the holding company 204 may curate ideas by having input into selecting ideas for patent coverage. The holding company 204 may have the ability to accept or reject ideas for patent coverage, and in some agreements, the startup company 202 may also enjoy the ability to accept or reject ideas for patent coverage.

The curation performed in block 218 may involve determining a long term strategy for patent coverage, where that strategy may protect the startup company 202 and position the patent portfolio for long term value. In a typical curation, the holding company 204 may identify competitors, prior art, potential purchasers, licensing opportunities, and other factors that may help determine how to pursue patent coverage. In many cases, the startup company 202 may have large amounts of input, and sometimes control or veto authority, in the curation process.

The holding company 204 may file patent applications in block 220. The filing may be paid for by the holding company 204, as well as the attorney's fees and other expenses.

The holding company 204 may have an agreement to file a certain number of patent applications, and such an agreement may or may not include foreign patent filing. The agreement may include utility patents, design patents, plant patents, or any other type of intellectual property coverage.

The startup company 202 may fail to make the prescribed payments in block 222. The holding company 204 may detect the failure to pay in block 224, and may exercise its ability to reduce the license rights in block 226. From that point forward, the startup company 202 may receive reduced license rights in block 228. The holding company 204 may also be authorized to license or sell the patents or patent rights to other companies in block 230.

The process of blocks 222 through 230 may represent one transition point of an agreement between the startup company 202 and holding company 204, where the rights of block 212 are reduced or terminated in block 228 for lack of payment.

The startup company 202 may have the ability to selectively terminate patent applications or groups of patent applications, or may be required to maintain all or none of the portfolio. When such an election is made, the startup company 202 may notify the holding company 204 of its intent.

In some cases, the startup company 202 may fail to make a payment, and such a failure may be unintentional. In such a case, the holding company 204 may send a notice to the startup company 202 and may give the startup company 202 an opportunity to restore its status by paying the past due fees.

The reduced license rights in block 228 may be any reduction in the license rights granted in block 212. One type of reduction may be the complete reduction of patent rights, such that the startup company 202 may be prohibited from practicing the patented inventions. Another type of reduction may transition from an exclusive license to a non-exclusive license, while still another type of reduction may transition from an exclusive license in a wide range of geographies or usages of the patented technology to a much more narrow or restrictive license.

The holding company 204 may have the ability to license or sell the technology to third parties in block 230. The holding company 204 may be able to license competitors to the startup company 202, to sell some or all of the portfolio to non-practicing entities or licensing companies, or otherwise monetize the portfolio.

The startup company 202 may exercise a right in block 232 to buy out the holding company 204. A buyout transaction may be initiated in block 234 by notifying the holding company 204, which may receive a buyout payment in block 236. The holding company 204 may transfer the intellectual property assets in block 238, and the startup company 202 may enjoy full ownership of the assets in block 240.

A buyout option may be exercised by the startup company 202 in many situations. In a typical example, the startup company 202 may exercise a buyout option as part of an acquisition transaction. In such a transaction, the acquiring company may not wish to continue the agreement with the holding company 204, and therefore may buyout the holding company's position in the patent portfolio.

The buyout option may be exercised in some circumstances identified in a contract between the startup company 202 and the holding company 204. For example, a provision in the contract may require that the startup company 202 exercise a buyout option prior to litigating one or more patents in the portfolio, or for certain actions that may encumber the portfolio. Examples of such a restriction may include predefined set of sublicensing situations, cross-licensing, using portions of the portfolio for financing, or other situations.

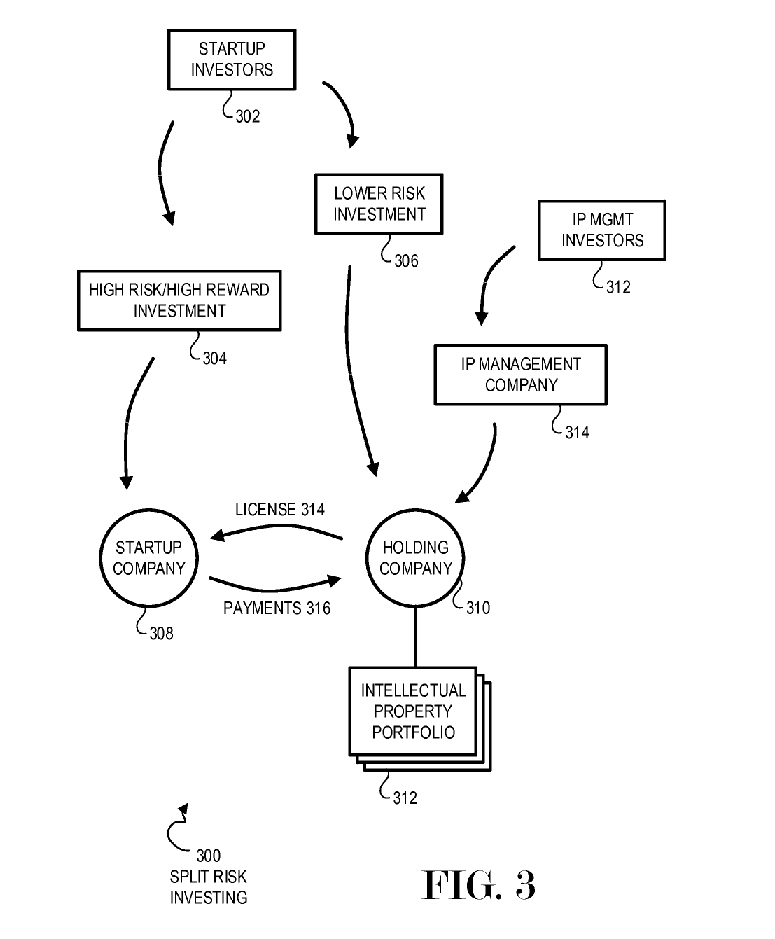

FIG. 3 is a diagram illustration of an embodiment 300 showing simplified interactions of an arrangement for separating risk in a startup company investment by using a holding company. Embodiment 300 is merely one simplified example of the relationships and interactions between various entities where an intellectual property portfolio 312 may be held in a holding company 310 for the benefit of a startup company 308.

Embodiment 300 is one example of an arrangement where an investor 302 who wishes to invest in a startup company 308 may separate the investment into a high risk/high reward investment 304 and a lower risk investment 306.

The high risk/high reward investment 304 may be investment in the startup company 308. In such an investment, the investor 302 may take equity, convertible note, convertible debt, or some other instrument that may provide capital to the startup company 308. Such an investment may expect that the investment may be returned in an increase in value in the equity, and in some cases, the return may include dividends or other payments.

A lower risk investment 306 may involve an investment in the holding company 310. The holding company 310 may be backed by an intellectual property portfolio 312 that may be built for the benefit of the startup company 308. Such an investment may be considered lower risk as it may be backed by the assets of the portfolio 312.

Some investors may consider the high risk/high reward investment 304 in the startup company 308 to be an investment in the company founders, the business plan, and the company's ability to execute. The lower risk investment 306 may be a longer term investment in the technology. Because the intellectual property may represent an emerging technology, it may take several years before such a portfolio may have value. If the startup company 308 were to fail, or if the startup company 308 may elect to pursue different technologies, the investment in the intellectual property portfolio 312 may still realize a return to investors.

The holding company 310 may be operated and managed by an IP management company 314. The IP management company 314 may have its own investors 312, and may operate many holding companies, each having its own intellectual property portfolio.

The IP management company 314 may permit investment in individual holding companies, such as the holding company 310. In such a case, the IP management company 314 may accept investment from the startup investors 302 and may manage the holding company 310. The lower risk investment 306 may have returns that may include a portion of the payments 316 made by the startup company 308, as well as any income that may be received by the holding company 310 if the startup company 308 exercises its option to buy back the intellectual property portfolio 312 or if the IP management company 314 liquidates or monetizes the portfolio 312.

The combination of a high risk and low risk investments may increase the startup company's opportunity for success. The lower risk investment in the holding company 310 may be used to create a large asset in the portfolio 312 that gives the startup company 308 many advantages in the marketplace. The lower risk investment 306 is augmented by the investment made by the holding company 310, thereby multiplying the startup investor's total investment.

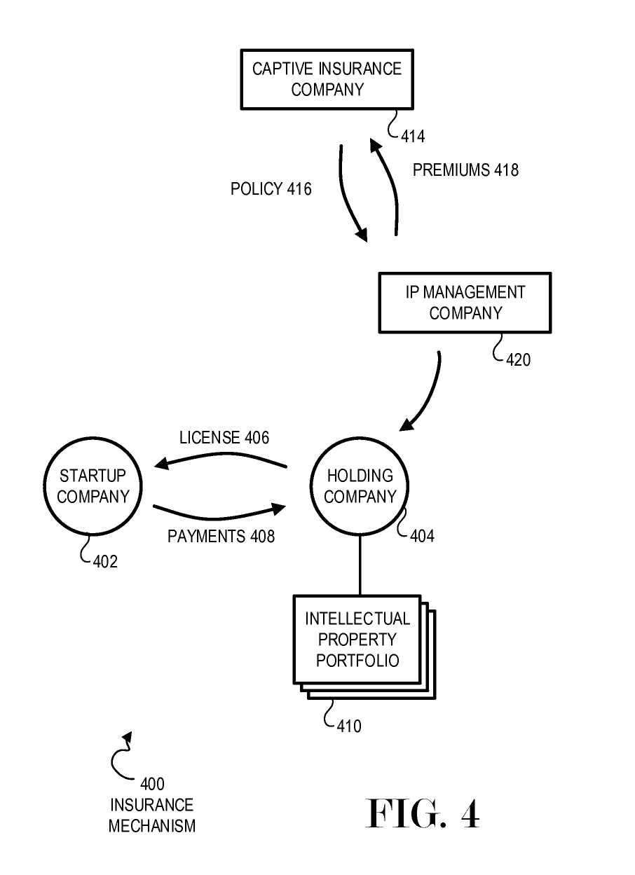

FIG. 4 is a diagram illustration of an example embodiment 400 showing a simplified version of an arrangement having an insurance mechanism. Embodiment 400 may illustrate where a captive insurance company 414 or other insurer may write a policy 416 that may protect investments made by an IP management company 420.

A startup company 402 may have an arrangement with a holding company 404. The holding company 404 may hold an intellectual property portfolio 410, and may give a license 406 to the startup company 402 in exchange for payments 408. An IP management company 420 may invest in the intellectual property portfolio 410 by curating ideas, drafting and filing patent applications, prosecuting patent applications, obtaining domestic and foreign patent protection, and other services related to the intellectual property portfolio 410.

The IP management company 420 may be making a substantial investment in the holding company 404 and may not realize a profit on such an investment for several years. Depending on how such an arrangement is made, profit may not be realized until the startup company 402 exercises a buyout option, or until many years of payments have been received. During this period of time, the IP management company 420 may be taking a risk that the startup company 402 may cease making payments, that the technology in the intellectual property portfolio 410 may not be salable, licensable, or otherwise not able to be monetized.

The IP management company 420 may use a captive insurance company 414 or other insurer to write a policy 416 to protect against a loss, such as the startup's failure to pay or the technology value in a liquidation or monetization event. In exchange for the policy 416, the IP management company 420 may pay premiums 418.

The insurance policy 416 may permit the IP management company 420 to file a claim and receive an insurance payout when one of the conditions in the policy are met. Such a policy may hedge the risk that the IP management company 420 may take in any particular startup company, and may be a vehicle for spreading the risk of investments across many different intellectual property portfolios.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

1. A business method performed by a first party, said method comprising:
identifying a patentable idea, said patentable idea being owned by said first party;
causing a first transfer of said patentable idea to a second party;
said second party filing a first patent application on said first patentable idea and granting a first license agreement for said first patentable idea to said first party;
paying said second party a first predetermined sum on a recurring basis in exchange for said first license agreement, said first license agreement being an exclusive license agreement, said first predetermined sum and said recurring basis being defined in an agreement;
during a period of time while said first predetermined sum is being paid on said recurring basis, exercising a first set of rights under said exclusive license agreement; and
failing to pay said first predetermined sum on said recurring basis as defined in said agreement, and having said first set of rights change to a second set of rights, said second set of rights being fewer rights than said first set of rights.

2. The method of claim 1 further comprising:
receiving a buy-back provision as part of said first set of rights, said buy-back provision comprising a second predetermined sum;
paying said second predetermined sum to said second party and causing a second transfer of said patentable idea to said first party while stopping an obligation to pay said first predetermined sum on said recurring basis to said second party.

3. The method of claim 2, said second transfer being an ownership transfer of said patentable idea.

4. The method of claim 2, said second transfer being an ownership transfer of said second party to said first party.

5. The method of claim 1, said second party being a holding company.

6. The method of claim 5, said first party having a first set of investors and said second party having a second set of investors.

7. The method of claim 6, said first set of inventors not intersecting with said second set of inventors.

8. The method of claim 6, said first set of investors comprising at least one investor in common with said second set of investors.

9. The method of claim 1, said first predetermined sum being a recurring sum that is fixed for a predetermined period of time.

10. The method of claim 1, said first predetermined sum being a recurring sum that varies over time.

11. The method of claim 10, said first predetermined sum being variable based on a patent status of said first patentable idea.

12. The method of claim 11, said patent status comprising at least one of patent pending and issued.

13. The method of claim 10, said first predetermined sum being variable based on a sublicense income received by said first party from a third party.

14. The method of claim 13, said sublicense income being applied at least in part to said first predetermined sum.

15. The method of claim 1, said first transfer comprising a sale of said first patentable idea from said first party to said second party.

16. The method of claim 1, said first transfer comprising an assignment of said first patentable idea from said first party to said second party.

17. A business method performed by a holding company, said method comprising:
receiving a patentable idea from a first party;
granting a first license arrangement for said first patentable idea to said first party and receiving payments from said first party according to a first payment schedule;
filing a patent application on said patentable idea and prosecuting said patent application to issuance as a patent;
while said payments are being received according to said first payment schedule, maintaining said first license arrangement with said first party; and
determining that said payments have not been received according to said first payment schedule and changing said first license arrangement to a second license arrangement, said second license arrangement having more restrictive rights than said first license arrangement.

18. The method of claim 17, purchasing said patentable idea from said first party as part of said receiving said patentable idea from said first party.

19. The method of claim 18, treating said patentable idea as a capital purchase.

20. The method of claim 17, said first license arrangement being an exclusive license arrangement.

21. The method of claim 20, said exclusive license arrangement comprising a right to sublicense to a third party.

22. The method of claim 21, said sublicense being made by said first party as an agent of said holding company, said sublicense comprising second payments according to a second payment schedule, said second payments being payable to said holding company.

22. (canceled)

23. The method of claim 22, said sublicense further comprising a portion of said second payments being payable to said first party.
